(19) United States
(12) Patent Application Publication
(10) Pub. No.: US 2023/0121276 A1
(43) Pub. Date: Apr. 20, 2023

(54) QUALITY ASSURANCE METHOD FOR AN EXAMPLE-BASED SYSTEM

(71) Applicant: Siemens Mobility GmbH, München (DE)

(72) Inventor: Thomas Waschulzik, Freising (DE)

(21) Appl. No.: 17/910,886

(22) PCT Filed: Feb. 24, 2021
(86) PCT No.: PCT/EP2021/054507

§ 371 Date: Sep. 12, 2022

(30) Foreign Application Priority Data
Mar. 11, 2020 (DE) 10 2020 203 135.5

(51) Int. Cl. G06F 18/214; G06N 3/08; G06F 18/21

(52) U.S. Cl. CPC G06F 18/214; G06F 18/2163; G06N 3/08

(57) ABSTRACT

A quality assurance method for an example-based system improves quality assurance by creating and training the example-based system on the basis of collected examples that form a set of examples. A respective example in the set of examples includes an input value that is situated in an input space. A quality assessment representing a coverage of the input space by examples in the set of examples is ascertained on the basis of a distribution of the input values in the input space. A computer program and a computer-readable storage medium are also provided.

The invention relates to a quality assurance method for an example-based system.

Example-based systems, such as artificial neural networks, are known in principle. These are generally used in areas in which a direct algorithmic solution does not exist or cannot be suitably created using conventional software methods. By using example-based systems it is possible to create and train a task on the basis of a set of examples. The learned task can be applied to a set of further examples.

The dissertation “Quality-Assured Efficient Engineering of Feedforward Neural Networks with Supervised Learning (QUEEN)” by Thomas Waschulzik describes the development of feedforward artificial neural networks with supervised learning (in the following: WASCHULZIK).

Set against this background, it is the object of the invention to improve quality assurance for an example-based system.

This object is inventively achieved by a method for quality assurance of an example-based system, in which the example-based system is created and trained on the basis of collected examples that form a set of examples. The respective example in the set of examples comprises an input value that is situated in an input space. A quality assessment (or a quality indicator), which represents a coverage of the input space by examples in the set of examples, is ascertained on the basis of the distribution of the input values in the input space.

The invention is based firstly on the recognition that example-based systems, such as neural networks, are frequently regarded as a black box. In this case the internal information processing is not analyzed and no coherent model is created. Furthermore, the system is not verified by an inspection. This results in caveats when using example-based systems in tasks with a high level of criticality.

The invention is furthermore based on the recognition that when examples for creating and training the example-based system are captured it is frequently not known how many examples need to be collected in which areas of the input space in order to create a suitable knowledge base.

The inventive solution remedies these problems by ascertaining the coverage of the input space using examples on the basis of the distribution of the input values in the input space. As a result, a mapping of the input space is achieved which serves as the basis for the further capture of examples for the creation of a suitable knowledge base. Thus the capture of the examples can be controlled in accordance with the distribution in the input space, although the specific type of classifier or approximator has not yet been specified. Nor need the number of degrees of freedom with which the knowledge base is trained be specified as yet. Thanks to the knowledge of the regions in which further examples need to be captured, the examples can be captured more selectively and consequently the costs for the capture of examples can be considerably reduced (since fewer examples need to be captured overall).

With the invention it has moreover been recognized that a prerequisite for the use of mappings of the input space for example-based systems is a suitable representation and encoding of the features. The raw data is converted by application-specific transformations into a representation adapted to the solution of the task. This representation is converted with the help of standard methods, such that it can be used as an activity of the input neurons of a neural network (known as encoding). The quality assessment, which represents the coverage of the input space by examples in the set of examples, can be employed at the level of the representations and at the level of the encodings.

The invention is further based on the recognition that the encoding and/or representation of the input features in the input space preferably have a semantic relationship to the desired output of the example-based system. Thus for example pixel values of an RGB image are unsuitable as an input for the classification – invariant as regards size, rotation and translation – of objects. The mapping of the input space should preferably be carried out if for example features that have a semantic relationship to the outputs are determined by preprocessing.

The invention is further based on the recognition that the ratio between the number of independent input features that determine the dimension of the spanned state space, and the number of examples to be captured for the configuration, training, evaluation and testing of the system is preferably not too large: this is because the coverage of the input space by examples is not sufficient in the event of a large ratio.

The invention is further based on the recognition that the dimensions that span the state space are preferably semantically independent of one another (i.e. represent independent aspects of the object). Further preferably, the dimensions for the solution of the task are of equal relevance.

Further preferably, only a single classification task or approximation task is taken into consideration for the quality assurance. For example, in an artificial neural network that is used as a single-shot multibox detector (SSD), only the classification for a predefined object size in what is known as a default box (i.e. with a predefined aspect ratio, with a predefined scaling and at a predefined position in the image) is taken into consideration.

The example-based system is preferably provided for use in a safety-oriented function. The person skilled in the art understands the term “safety-oriented function” to mean a function of a system that is relevant to safety, i.e. the behavior of which influences the safety of the area surrounding the system. In technical usage “safety” refers to the aim of protecting the environment of a system against hazards emanating from the system. In contrast to this, in technical usage the aim of protecting the system against hazards emanating from the environment of the system is referred to as “security”.

In a preferred form of embodiment of the inventive method, ascertainment comprises the distribution of representatives in the input space and the assignment of a number of examples in the set of examples to the respective representative. The examples assigned to the representative are situated in an area surrounding the input space which surrounds the representative. As a quality assessment, a local quality assessment for the surrounding area is ascertained.

By assigning the examples from the set of examples to the representatives, example data sets within the surrounding areas are determined, and are assigned to the representatives. The local quality assessments are calculated for each of these example data sets.

The division of the set of examples into multiple surrounding areas brings with it the advantages that generally result from the divide-and-rule method approach known from information technology. Thus for example a developer of the example-based system can concentrate on those parts of the input space in which particular quality criteria are not fulfilled by the ascertained quality assessment. In these parts the quality can be checked accordingly and if necessary improved. As a result, the work entailed in assessing the overall set of examples is considerably reduced.

A proxy example is preferably distributed as a representative. The distribution is preferably an equal distribution. In this case for example a grid for the arrangement of the proxy examples is selected in the input space. The grid can be specified individually for each dimension of the input space. One criterion for the specification of the grid, for example in the case of categorical variables, can be a model of target properties of the distribution of examples in the input space that is set on the basis of the requirements for the example-based system. The grid can be hierarchically structured, in order for example to map hierarchical encodings. When using a grid for the arrangement of the proxy examples a proxy example is distributed in each hypercube in the input space of the grid. With a hierarchical structure of the grid one proxy example is distributed per hierarchy level.

Alternatively the representative is a center of a cluster that is determined by means of a cluster method. The cluster method is preferably used to determine the position and to determine the extent of the respective cluster in the input space. Further preferably, the cluster method is carried out with consideration of output values of the examples that are situated in an output space. The clusters can be specified on the basis of requirements for properties of the example-based system or on the basis of a subset of example data. In the application of the example-based system a set of examples can for example be captured in an early phase, said examples being selected on the basis of knowledge about the fulfillment of the requirements. This distribution of the example data is then quality-assured. Further examples with the same distribution can be captured in a subsequent project phase. In this case each example of the quality-assured set of examples constitutes a representative for the subsequent phase of the capture of the examples. As a result it is ensured that for each initial example an additional quality-assured set of examples is captured. The position of the representative can for example be specified by the center of the cluster. Alternatively a hierarchical cluster method can be used, in which one representative is inserted per cluster and per hierarchy level and in which each example per hierarchy level is assigned to a cluster and consequently to a representative. The set of the examples that is available for the calculation of the quality assessment is then assigned to the clusters and consequently to the representative by way of a predefined metric. For an example that cannot be assigned to any cluster, a new cluster containing a representative is preferably created. Alternatively this example, together with further examples that it was not possible to assign to any cluster, is captured separately by a quality assessment.

Further preferably, the examples are not assigned to a representative in full, but only to a predefined portion. This may happen for example if a cluster algorithm is used that supplies a partial assignment of the examples to the example data sets (for example a percentage-based assignment to multiple surrounding areas, wherein the product of the sum of the portions is 1). When ascertaining the quality assessments on the basis of this partial assignment the respective example is taken into consideration in accordance with the associated portion.

The quality assessment is preferably ascertained on the basis of the number of examples assigned to the respective representative or on the basis of other features. This is particularly advantageous if the specific examples are no longer used in the subsequent procedure. Alternatively or additionally the specific examples or a reference to the examples are stored in the representative (transformation of the example data set into a structure oriented to the topography of the input space). This is advantageous if the specific examples are required in the subsequent procedure.

The memory space required for the processing is preferably reduced because the representatives are then stored only if at least one example is situated in the respective surrounding area. If the coverage of the input space is ascertained, the surrounding areas in which no representative has been created is evaluated as “no example present”. Nevertheless a histogram of the number of examples per representative can be created, since the number of surrounding areas in which no example has been captured can be determined with little effort (sum of the representatives to be expected - representatives created = number of fields without captured examples).

In accordance with a further preferred form of embodiment of the inventive method the quality assessment comprises a statistical average that is ascertained on the basis of the set of examples and/or of the examples assigned to a respective representative.

In this way it is possible, on the basis of the information assigned to the representatives, to define quality assessments, for example using means from descriptive statistics (as described in one of the following textbooks: “Statistik: Der Weg zur Datenanalyse” [Statistics: The way to data analysis](Springer textbook) paperback – 15 Sep. 2016 by Ludwig Fahrmeir (author), Christian Heumann (author), Rita Künstler (author), Iris Pigeot (author), Gerhard Tutz (author); “Statistik fur Dummies” [Statistics for Dummies] paperback – 4 Dec. 2019 by Deborah J. Rumsey (author), Beate Majetschak (translator), Reinhard Engel (translator); “Arbeitsbuch zur deskriptiven and induktiven Statistik” [Workbook on descriptive and inductive statistics] (Springer textbook) paperback – 27 Feb. 2009 by Helge Toutenburg (author), Michael Schomaker (contributor), Malte Wißmann (contributor), Christian Heumann (contributor)).

In a preferred development a histogram of the number of examples assigned to a representative is created as a statistical average.

As a result, a particularly simple and intuitive opportunity for evaluating and presenting the coverage of the input space is achieved.

The person skilled in the art preferably understands the wording “of the number of examples assigned to a representative” to mean that the values of the number of examples assigned to a representative are binned for the creation of the histogram (i.e. subdivided into areas).

In accordance with a further preferred development a statistical measurement, in particular an average value, median, minimum, maximum and/or quantiles of the number of examples assigned to a representative, is ascertained as a statistical average.

According to a further preferred development adjacent surrounding areas are ascertained in the input space, to the respective representative of which a number of examples is assigned which fulfills a predefined quality criterion of the quality assessment.

The predefined quality criterion is preferably fulfilled if the number of examples assigned to a respective representative undershoots or exceeds a predefined quality threshold value or is situated in a predefined quality band of the quality assessment.

When determining whether two surrounding areas are adjacent to one another, different neighborhood relationships can be used, for example the Von Neumann neighborhood (also called the 4-neighborhood), the Moore neighborhood (also called the 8-neighborhood) or the neighborhood from graph theory. The defined neighborhood relationships must be transferred accordingly in the case of higher-dimensional spaces: thus in three-dimensional space for example the 6-neighborhood is taken into consideration for cuboids with common surfaces, the 18-neighborhood for cuboids with common edges and the 26-neighborhood for cuboids with common corner points. The neighborhood is in this case defined by the number of dimensions in which two grid points may be differentiated, in order still to be regarded as adjacent.

In a preferred development a relationship area is ascertained within the input space and consists of adjacent surrounding areas, to each of the representatives of which a number of examples is assigned that fulfills a predefined quality criterion.

The predefined quality criterion is preferably fulfilled if the number of examples assigned to a respective representative undershoots or exceeds a predefined quality threshold value or is situated in a predefined quality band of the quality assessment.

When the quality criterion is fulfilled by a predefined quality threshold value being undershot, it is particularly advantageously possible to ascertain the location and size of areas of the input space in which too few examples have been captured (as it were “holes in the input space”). In other words: a particular advantage of the form of embodiment is that subareas of the input space can identified in which the values of the examples do not provide a sufficient basis for a safety-critical application. This in turn has the advantage that it is possible to intervene correctively, for example by capturing further examples or by restricting the knowledge base in the application to the relationship areas that are of high quality.

In particular the advantage of ascertaining the areas in which too few examples have been captured is that attacks by adversarial examples can be preventively countered. This is because in these areas the likelihood of success of an attack by an adversarial example is comparatively high. It can be reduced by capturing further examples in these areas or by restricting the knowledge base to the relationship areas that are of high quality.

Quality assessments can be calculated on the basis of the ascertained relationship areas. Thus for example the number of representatives in a relationship area can be determined. Histograms of the size or further properties of a relationship area can be created. Furthermore, statistical measurements, such as an average value, median, quantiles or standard deviations from properties of the relationship areas, can be calculated. Moreover, the extent of the relationship areas can be ascertained in the dimensions of the input space. The dimensions can be ordered in the sequence of the greatest extent of the relationship area.

According to a further preferred form of embodiment of the inventive method, further examples are captured in the respective surrounding area if the quality assessment ascertained for the respective surrounding area is less than a predefined quality threshold value. Alternatively or additionally examples are removed from a respective surrounding area if the quality assessment ascertained for the respective surrounding area is greater than a predefined quality threshold value.

According to a particularly preferred form of embodiment of the inventive method the respective example comprises an output value that is situated in an output space. For the respective surrounding area a local complexity assessment is ascertained that represents a complexity of a task of the example-based system defined by the examples in the surrounding areas. The local complexity assessment is determined by the location of the examples in the surrounding area relative to one another in the input space and output space.

The person skilled in the art preferably understands the wording “location of the examples in the surrounding area relative to one another in the input space and output space” to mean that the complexity assessment is defined based on the consideration of the similarity of the spacings of the examples in the input space to the spacings in the output space. For example, the task of the example-based system has comparatively little complexity if the spacings in the input space (apart from the scaling) correspond approximately to the spacings in the output space.

The advantage of this is that examples can be effectively captured. This is because, on the basis of the complexity assessment, areas are known in which because of the high complexity of the task of the example-based system a comparatively high number of examples has to be captured. The density of the representatives is preferably increased dynamically in areas of the input space in which a higher complexity is present, until a homogeneous complexity is achieved is and a sufficient set of examples is situated in the surrounding area of the representatives.

The complexity assessment corresponds for example to the quality indicators described in section 4 (QUEEN quality indicators) of WASCHULZIK. These quality indicators can be defined and used for both the representation or encoding of the features (cf. section 4.5 of WASCHULZIK).

In accordance with a preferred form of embodiment of the inventive method the integrated quality indicator QI² in accordance with section 4.6 of WASCHULZIK is taken as the quality indicator for the representations, and in accordance with formula 4.21 is defined as follows:

$$Q {I}^{2} \left(P\right) = \frac{1}{\left|{P}^{2}\right|} {\sum }_{{x}_{i} ∈ {P}^{2}} {\left({d}_{N R E} \left({x}_{i}\right) - {d}_{N R A} \left({x}_{i}\right)\right)}^{2}$$

wherein in accordance with formula 4.18 in WASCHULZIK:

$$\frac{{d}_{N R E} \left(x\right) = {d}_{R E} \left(x\right)}{\frac{{\sum }_{y ∈ {P}^{2}} {d}_{R E} \left(y\right)}{\left|{P}^{2}\right|}}$$

is the normalized spacing of the represented inputs (NRE) and

$$\frac{{d}_{N R A} \left(x\right) = {d}_{R A} \left(x\right)}{\frac{{\sum }_{y ∈ {P}^{2}} {d}_{R A} \left(y\right)}{\left|{P}^{2}\right|}}$$

is the normalized spacing of the represented outputs (NRA). In this case x is the pair (x₁,x₂,) consisting of the two examples x₁ and x₂. x₁and x₂ are examples from the set of examples P. P = {p₁,p₁,...,p_{|P|}} is the set of elements from BAG P, wherein |P| is the number of elements in the BAG P.

BAG is a multiset (also called a bag), as is defined in specification 21.5 on page 27 of the appendix to WASCHULZIK. The task QAG is defined in definition 3.1 on page 23 of WASCHULZIK, where it is referred to as a QUEEN task.

d_{RE}(X) is an abbreviation for the spacing in the input space dᵣₑ(νepₓ₁, νepₓ₂) and d_{RA}(x) is an abbreviation for the spacing in the output space dᵣₐ(νapₓ₁, νapₓ₂).

The definition of the spacing between the representation of two examples in accordance with WASCHULZIK is based on the Euclidian norm. Thus the spacing in the input space is defined as (see formula 4.3 in WASCHULZIK):

$${d}_{r e} \left({p}_{k 1} , {p}_{k 2}\right) = \sqrt{{\sum }_{i = 1}^{a e m} {\left(v e m {p}_{i , k 1} - v e m {p}_{i , k 2}\right)}^{2}}$$

with Pₖ₁,Pₖ₂ as examples from the set P, wherein

$$\begin{matrix}{p}_{k} = \left(v e {p}_{k} , v a {p}_{k}\right) = \\ \left(\begin{matrix}\left(v e m {p}_{1 , k} , v e m {p}_{2 , k} , … , v e m {p}_{N u m b e r I n p u t F e a t u r e s , k}\right) , \\ \left(v a m {p}_{1 , k} , v a m {p}_{2 , k} , … , v e m {p}_{N u m b e r O u t p u t F e a t u r e s , k}\right)\end{matrix}\right)\end{matrix}$$

where
i running index of all characteristics;
vemp_{i,kx} characteristic of the input feature i of the example kx where kx ∈ R (R is the set of real numbers); and
αem NumberInputFeatures of the task QAG.

In a preferred development an aggregated complexity assessment is ascertained by aggregating the local complexity assessments.

The advantage of the aggregated complexity is that developers of the example-based system can carry out their quality assurance with ease.

For example a histogram of the complexity in the various surrounding areas of the input space can be created as an aggregated complexity assessment. To this end the value range of the complexity assessments is binned (i.e. subdivided into ranges). Only the number of surrounding areas with corresponding complexity is preferably included in the bins, if the positions of the surrounding areas are no longer required. This histogram is preferably compiled using information about the number of examples, for example likewise in a histogram of the number of examples assigned to the representative. Further preferably information about the representative is stored in the histogram, so that said information can be accessed during detailed analyses.

In accordance with a further preferred development, on the basis of the aggregated complexity assessment surrounding areas are identified that have a complexity assessment that undershoots a predefined complexity threshold value. In the surrounding areas ascertained the task of the example-based system is implemented by an algorithmic solution. This is particularly advantageous for applications with high quality requirements, for example for safety-oriented functions.

This preferred development is based on the recognition that the exact mode of operation of the system (i.e. semantic relationships) for areas with a low complexity of the task is frequently known. In this case the task can be implemented as a conventional algorithm (instead of as an example-based system). This is particularly advantageous, since it is generally easier to demonstrate sufficient safety of the safety-oriented function in the context of an approval procedure for the simple algorithmic solution.

Another advantage of this development is that no further examples need to be captured in the areas of low complexity.

When searching for simple areas, a search is also preferably carried out for data collection artifacts that produce a relationship between input and output and that come about thanks to specific circumstances of the data collection, but do not represent a relationship that can be used in practice (as known for example from the “Clever Hans effect”: https://de.wikipedia.org/wiki/Kluger_Hans). In areas of particularly high complexity the examples are analyzed to see whether for example problems occurred during the collection and capture of the examples.

According to a further preferred form of embodiment of the inventive method the input space is divided up hierarchically on the basis of the quality assessment.

A hierarchical mapping of the input space is preferably achieved by the hierarchical division of the input space. The hierarchy is further preferably derived from the representation or encoding of the input feature and/or from the analysis of the complexity of the task.

By introducing an additional hierarchy in the analysis of the input space it is possible in the areas in which high complexity is present, either to dynamically increase the density of the representatives (until a homogeneous complexity is reached) or to introduce a new hierarchy level. The introduction of a new hierarchy level is done by adding a new subdivision with a higher resolution in the area of the representative. The procedure can be iterated by adding a further hierarchy step in the high-resolution area in the event of renewed increased local complexity. As a result the resolution can be dynamically adjusted to the respective task.

According to a further preferred form of embodiment of the inventive method a complexity distribution is ascertained by means of a histogram representation of the complexity assessment by way of k nearest neighbors of an example in the input space. In this way it is ascertained for the local surrounding area of an example how the complexity is distributed. In particular the characteristic of the complexity in the local surrounding area of the example is ascertained and as it were a fingerprint of the local surrounding area of the example is ascertained in respect of complexity.

The value range of the complexity assessments for the histogram representation is preferably binned (i.e. subdivided into areas). For example, the “binned” values are plotted on the y axis and the representation of the increase in k (of the k nearest neighbors) is entered on the x axis.

To reduce the computing capacity needed when ascertaining the complexity distribution, the increment of the values of k > 1 is selected. For example, a distribution of the complexity assessment is ascertained with an increment of 5 for the values of k=5, 10, 15, 20, etc. Further preferably the increment of k is only selected to be small in areas of special interest. Thus the distribution of the complexity assessment is for example first calculated with a comparatively large increment of k, in order to then use a small increment of k for calculation in an area of special interest.

Further preferably the number of the values in the complexity assessment is stored for the calculated histogram field (complexity assessment binned, k). Further preferably identification information (for example a number), which the example in the area surrounding which the complexity distribution was ascertained, is also stored.

In accordance with a further preferred form of embodiment of the inventive method the example-based system is provided for use in a safety-oriented function, wherein the safety-oriented function comprises object recognition based on image recognition in which the object is recognized using the example-based system.

In a preferred development the object recognition is used for automated operation of a vehicle, in particular of a track-bound vehicle, of a motor vehicle, of an aircraft, of a water vehicle and/or of a space vehicle.

The object recognition in the case of automated operation of a vehicle is a particularly expedient embodiment of a safety-oriented function. The object recognition is in this case necessary in order e.g. to recognize obstacles on the road or to analyze traffic situations in respect of priority for road users.

The motor vehicle is for example a car, e.g. a private car, a truck or a tracked vehicle.

The water vehicle is for example a ship or a submarine.

The vehicle can be manned or unmanned.

One example of an area of application is autonomous or automated driving of a rail vehicle. To solve the tasks use is made of object recognition systems in order to analyze scenes that are digitized with sensors. This scene analysis is necessary in order e.g. to recognize obstacles on the road or to analyze traffic situations in respect of priority for road users. Systems based on the use of examples with which parameters of the pattern recognition system are trained are currently being used particularly successfully for the recognition of objects. Examples of this are neural networks, e.g. using deep learning algorithms.

In accordance with a further preferred form of embodiment of the inventive method the example-based system is provided for use in a safety-oriented function, wherein the safety-oriented function comprises a classification on the basis of sensor data for organisms.

The tissue classification of animal or human tissue is a particularly expedient embodiment of a safety-oriented function in the area of medical image processing. The organisms for example comprise Archaea (primitive bacteria), Bacteria (true bacteria) and Eucarya (nucleates) or tissue of Protista (also called Protoctista), Plantae (plants), Fungi (fungi, chitin fungi) and Animalia (animals).

Further areas of application are the safe control of industrial plants (e.g. synthesis in chemistry, the control of production processes e.g. rolling mills), a classification of chemical substances (e.g. pollutants, warfare agents), a classification of signatures of vehicles (e.g. radar or ultrasound signatures) and/or control in the area of industrial automation (e.g. production of machinery).

According to a further preferred form of embodiment of the inventive method the example-based system comprises
a system with supervised learning,
a system that is structured with the methods of statistics,
preferably an artificial neural network with one or more layers of neurons that are not input neurons or output neurons and are trained with backpropagation,
in particular a convolutional neural network,
in particular a single-shot multibox detector network.

The use of artificial neural networks frequently enables an improvement in the classification or approximation output.

The one layer or multiple layers of neurons that are not input neurons or output neurons are frequently referred to by specialists as “hidden” neurons. The training of neural networks with many levels of hidden neurons is frequently also referred to by specialists as deep learning. A special type of deep learning networks for pattern recognition are known as convolutional neuronal networks (CNNs). A special case of CNNs are known as SSD networks (single-shot multibox). The person skilled in the art understands the term “single-shot multibox detector” to mean a method for object recognition in accordance with the deep learning approach, which is based on a convolutional neural network and is described in: Liu, Wei (October 2016). SSD: Single-shot multibox detector. European Conference on Computer Vision. Lecture Notes in Computer Science. 9905. pp. 21-37. arXiv:1512.02325

The invention further relates to a computer program, comprising commands which on execution of the program by a computing unit cause said computing unit to carry out the type of method described above.

The invention further relates to a computer-readable storage medium, comprising commands which on execution by a computing unit cause said computing unit to carry out the type of method described above.

For advantages, forms of embodiment and details of embodiment of the features of the inventive computer program and computer-readable storage medium, reference can be made to the above description for the corresponding features of the inventive method.

An exemplary embodiment of the invention is explained on the basis of the drawings, in which:

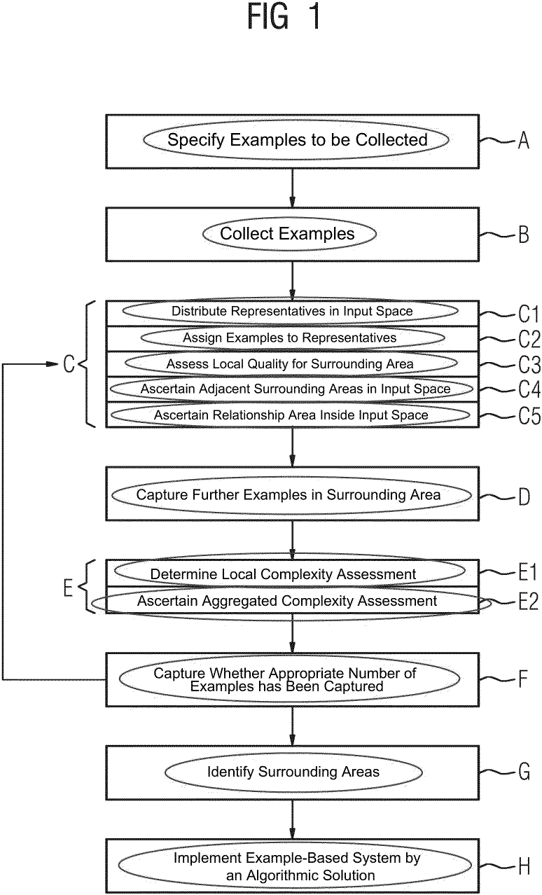

FIG. 1 schematically shows the sequence of an exemplary embodiment of an inventive method,

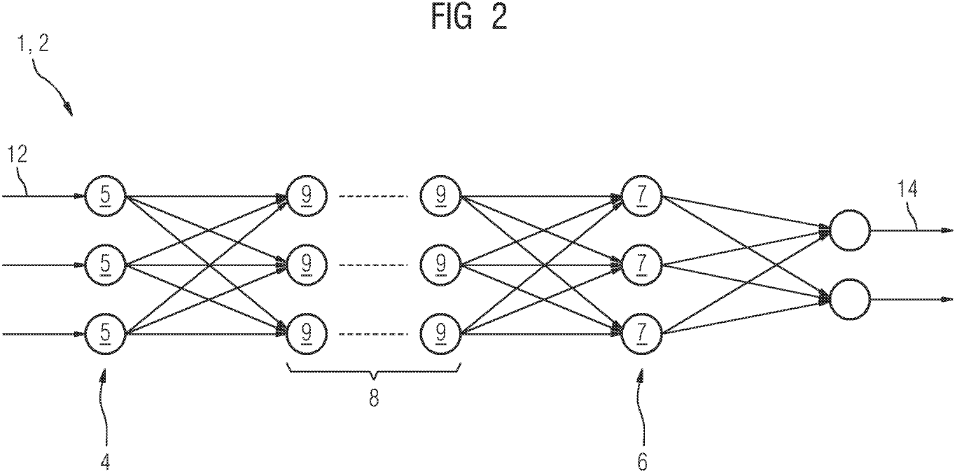

FIG. 2 schematically shows the structure of an example-based system in accordance with the exemplary embodiment of the inventive method,

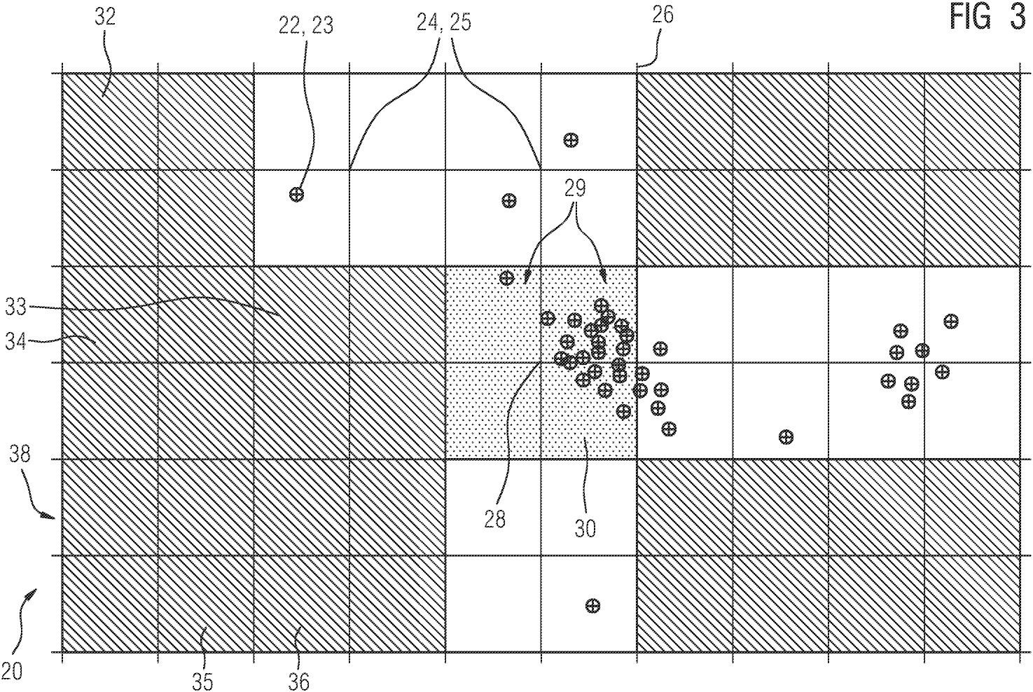

FIG. 3 schematically shows a two-dimensional input space in accordance with the exemplary embodiment of the inventive method,

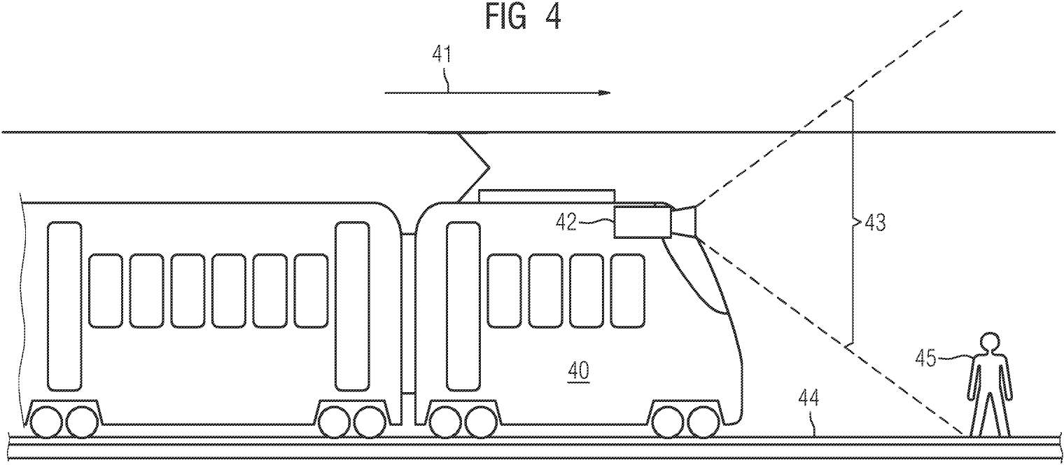

FIG. 4 shows a schematic side view of a track-bound vehicle situated on a track section,

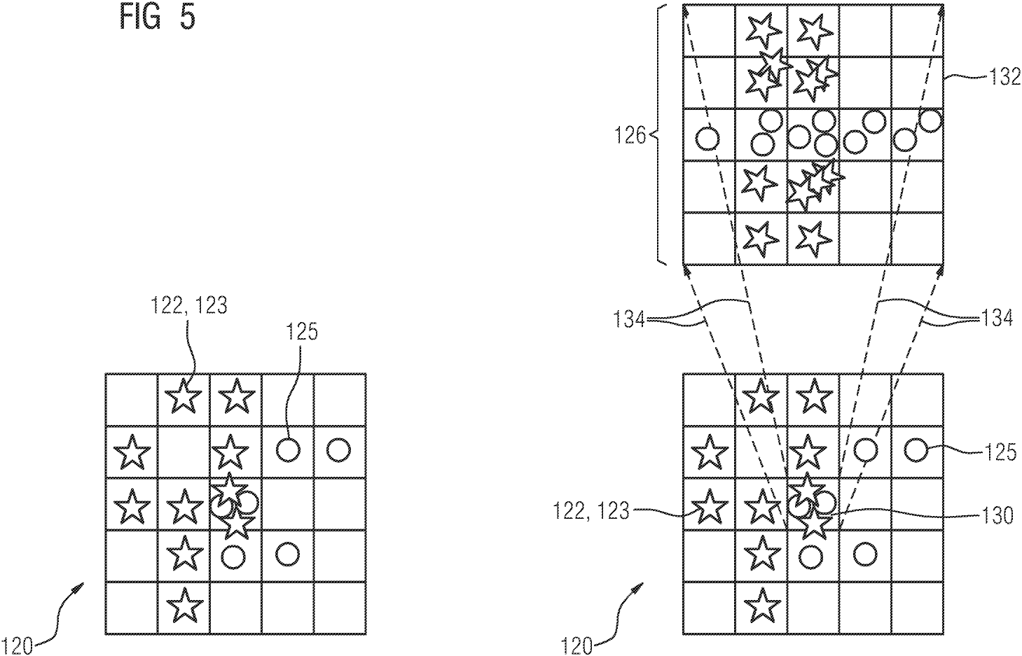

FIG. 5 shows a hierarchical division of the input space,

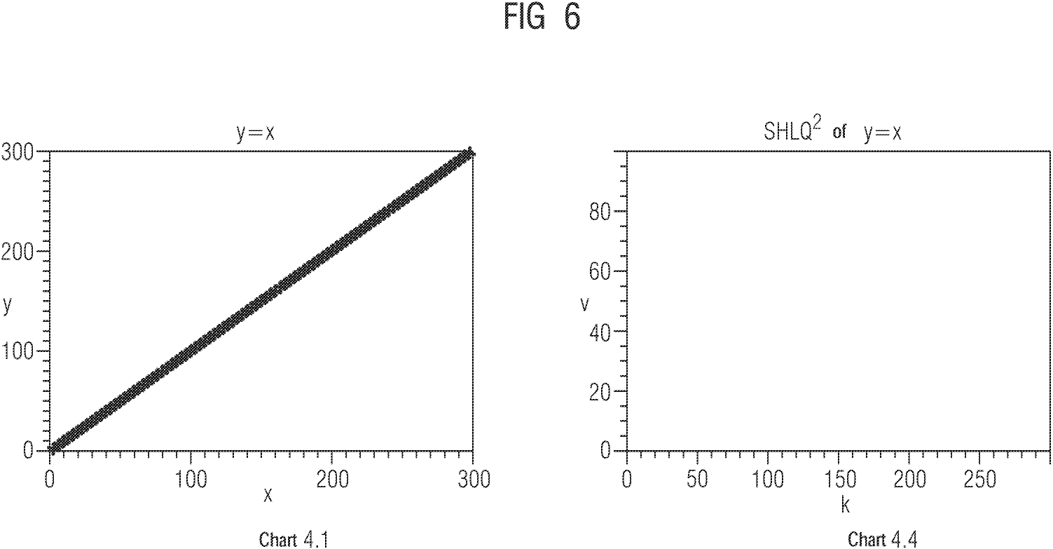

FIG. 6 shows two axis diagrams that represent the application of the complexity assessment to a first synthetic function,

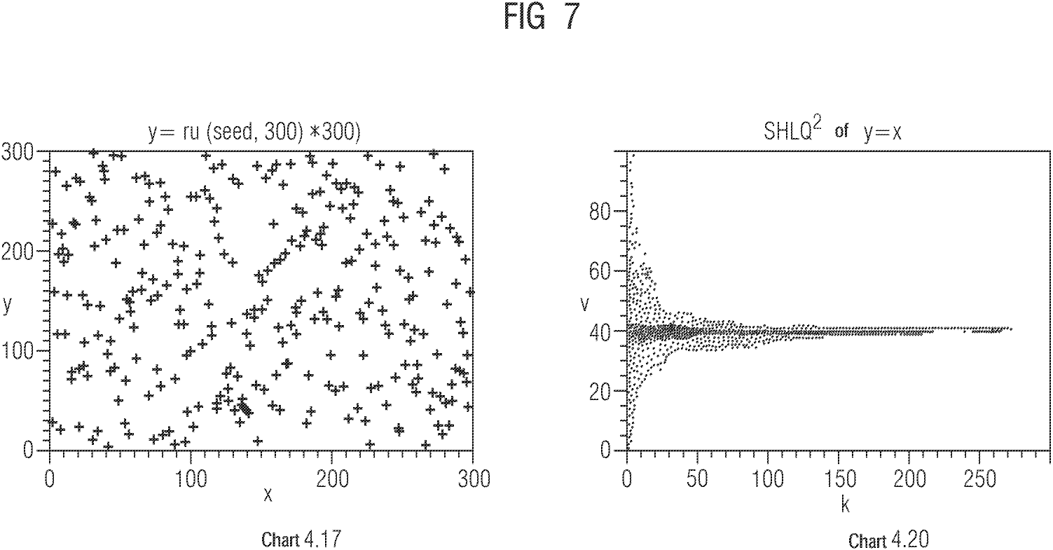

FIG. 7 shows two axis diagrams that represent the application of the complexity assessment to a second synthetic function,

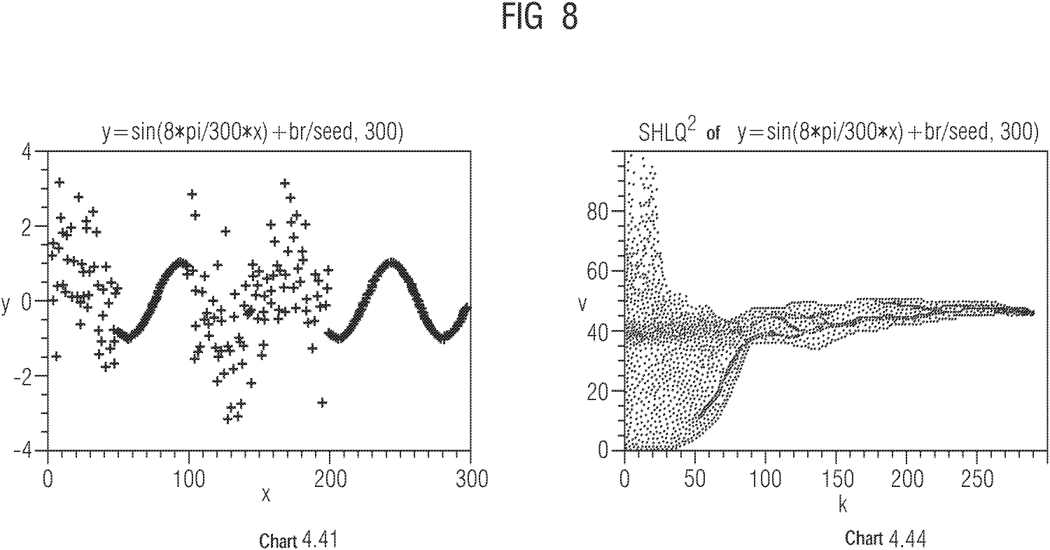

FIG. 8 shows two axis diagrams that represent the application of the complexity assessment to a third synthetic function, and

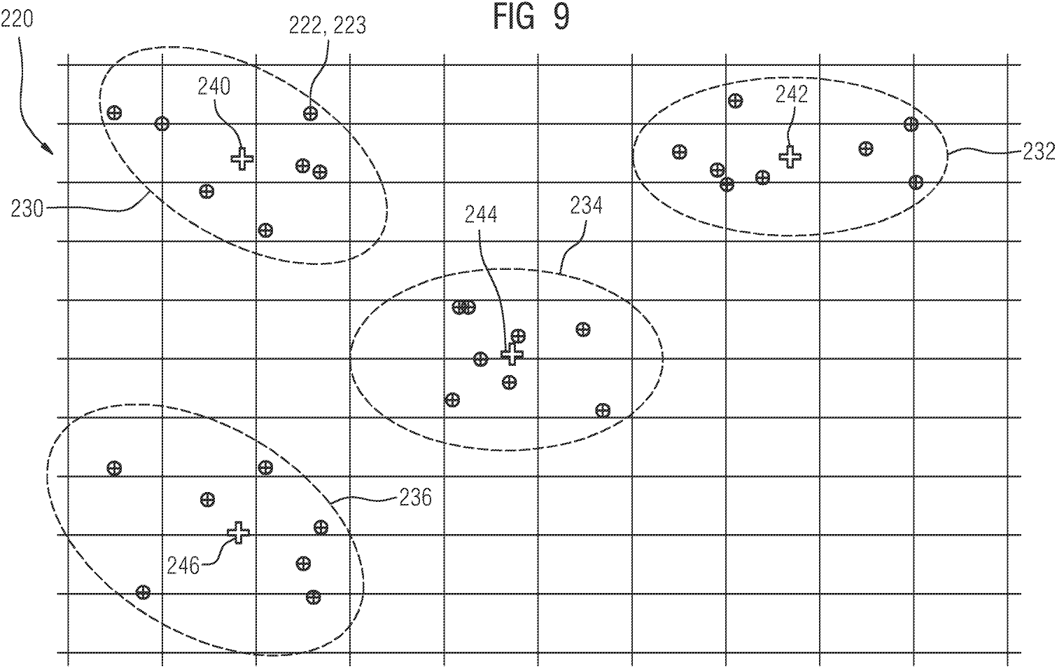

FIG. 9 schematically shows a further example of a two-dimensional input space in accordance with a further exemplary embodiment of the inventive method.

FIG. 1 shows a schematic flowchart that represents the sequence of an exemplary embodiment of an inventive method for the quality assurance of an example-based system.

FIG. 2 schematically shows the structure of an example-based system 1, in which the quality assurance of the system takes place by way of the exemplary embodiment of the inventive method. The example-based system 1 is a system with supervised learning and is formed by an artificial neural network 2 that has a layer 4 of input neurons 5 and a layer 6 of output neurons 7. The artificial neural network 2 has multiple layers 8 of neurons 9 that are not input neurons 5 or output neurons 7. The artificial neural network 2 is what is known as a multilayer perceptron, but can also be a recurrent neural network, a convolutional neural network, or in particular what is known as a single-shot multibox detector network.

The example-based system and the inventive method are implemented by means of one or more computer programs. The computer program contains commands which on execution of the program by a computing unit cause said computing unit to carry out the inventive method in accordance with the exemplary embodiment shown in FIG. 1. The computer program is stored on a computer-readable storage medium.

The example-based system is used in a safety-oriented function of a system. The behavior of the function therefore influences the safety of the area surrounding the system.

An example of a safety-oriented function is object recognition based on image recognition, in which the object is recognized using the example-based system 1. The object recognition is used for example in automated operation of a vehicle, in particular of a track-bound vehicle 40 shown in FIG. 4, of a motor vehicle, of an aircraft, of a water vehicle or of a space vehicle.

A further example of a safety-oriented function is a classification on the basis of sensor data for organisms, e.g. for Archaea (primitive bacteria), Bacteria (true bacteria) and Eucarya (nucleates) or for tissue of Protista (also called Protoctista), Plantae (plants), Fungi (fungi, chitin fungi) and Animalia (animals), safe control of industrial plants, classification of chemical substances, classification of signatures of vehicles or control in the area of industrial automation.

In a method step A it is specified which examples are to be collected. In a step B the examples are collected: the collected examples form a set of examples. The respective example has an input value 12 that is situated in an input space, and an output value 14 that is situated in an output space. In object recognition (as one of multiple possible examples of a safety-oriented function) for automated operation of the track-bound vehicle 40 shown in FIG. 4 the examples are collected by providing the track-bound vehicle 40 with a camera unit 42 for the capture of images. The camera unit 42 is oriented in the direction of travel 41 such that a spatial area 43 situated ahead in the direction of travel 41 is captured by the camera unit. The track-bound vehicle 40 travels with the camera unit 42 in the direction of travel 41 along a track section 44. To capture the examples, scenes that are relevant for the creation and training of the example-based system 1 for object recognition are reconstructed. Thus for example cardboard cutouts, crash test dummies or actors 45 are used to represent persons on the track section 44 that are to be recognized by means of the example-based system 1 to be created and trained. Alternatively scenes can be reconstructed by means of what is known as virtual reality.

In a method step C a quality assessment is ascertained that represents a coverage of the input space by examples in the set of examples. During the ascertainment C of the quality assessment, representatives are distributed in the input space in a method step C1. FIG. 3 shows as an example a two-dimensional input space 20. In actual application of the inventive method the input space and output space frequently have a higher dimensionality. The examples 22 in the set of examples are represented as cross-hairs 23 in FIG. 3. The representatives 24 are equally distributed and are represented as cross-points 25 of the grid 26 shown.

In a method step C2 a number of examples 29 in the set of examples is assigned to a respective representative 28. The examples 29 assigned to the representative 28 are situated in a surrounding area 30 of the input space 20 that surrounds the respective representative 28. The surrounding area 30 is for example represented in FIG. 3 as a dotted surface. A local quality assessment for the surrounding area 30 is in this case ascertained as a quality assessment in a method step C3.

In a method step C4 adjacent surrounding areas 32-36 are ascertained in the input space, to the respective representative of which a number of examples is assigned that undershoots a predefined quality threshold value. In FIG. 3 these surrounding areas 32-36 are represented as surfaces with diagonal stripes. The example shown in FIG. 3 in the case of the surrounding areas 32-36 relates to areas in which no example is situated. Moreover, in a method step C5 a relationship area 38 is ascertained inside the input space 20, that consists of the adjacent surrounding areas 32-36, to each representative of which a number of examples is assigned that undershoots a predefined quality threshold value. As a result the position and size of areas of the input space 20 in which too few examples have been captured are ascertained. In other words: subareas of the input space 20 are identified in which the example values do not provide a sufficient basis for a safety-critical application.

Based on the identification a corrective intervention is possible: to this end for example in a method step D further examples are captured in a respective surrounding area if the quality assessment ascertained for the respective surrounding area is less than a predefined quality threshold value.

In a method step E a local complexity assessment is ascertained for the respective surrounding area and represents a complexity of a task of the example-based system defined by the examples in the surrounding area. In this case the local complexity assessment is determined in accordance with a method step E1 by the location of the examples in the surrounding area relative to one another in the input space 20 and the output space. In other words, the complexity assessment is defined on the basis of the consideration of the similarity of the spacings of the examples in the input space 20 to the spacings in the output space. For example, the task of the example-based system has a comparatively low complexity if the spacings in the input space 20 (apart from the scaling) approximately correspond to the spacings in the output space. On the basis of the complexity, assessment areas are ascertained in which because of high complexity of the task of the example-based system a comparatively high number of examples has to be captured. For example, in areas of the input space 20 in which higher complexity is present, the density of the representatives is dynamically increased until a homogeneous complexity is achieved. Alternatively a new hierarchy level can be introduced (as is described below for example in respect of FIG. 5).

The complexity assessment corresponds to the quality indicators described in section 4 (QUEEN quality indicators) of WASCHULZIK. These quality indicators can be defined and applied for both the representation or encoding of the features (cf. section 4.5 of WASCHULZIK). An example of this quality indicator for the representations is the integrated quality indicator QI² in accordance with section 4.6 of WASCHULZIK.

In a method step E2 an aggregated complexity assessment is ascertained by aggregation of the local complexity assessment: for example, a histogram of the complexity in the various surrounding areas of the input space is created as an aggregated complexity assessment. To this end the value area of the complexity assessments is binned (i.e. subdivided into areas). Only the number of surrounding areas with corresponding complexity is included in the bins, providing the positions of the surrounding areas are no longer required. This histogram is compiled using information on the number of examples, for example likewise in a histogram of the number of examples assigned to the representative. Further preferably information on the representatives is stored in the histogram, so that said information can be accessed during detailed analyses.

Based on the complexity assessment it is possible in a method step F to capture whether an appropriate number of examples has been captured in all areas. If an area is identified in which too many examples have been captured with low complexity, examples can be removed from this area. This reduction of the examples reduces the need for storage space and the cost of the calculations, e.g. for the quality-assurance measures on the basis of the example data set. If an area is identified in which too few examples have been captured (e.g. since the complexity is comparatively high), further examples must be captured in this area where appropriate. The latter case frequently occurs in the areas in which a new hierarchy level has been introduced (as is described below for example in respect of FIG. 5). After further examples have been captured, a loop to the quality assurance (in accordance with the method steps C to E) is run through until all described quality requirements have been fulfilled.

Based on the aggregated complexity assessment in a method step G surrounding areas are identified, the complexity assessment of which undershoots a predefined complexity threshold value. In the ascertained surrounding areas the task of the example-based system is implemented in accordance with a method step H by an algorithmic solution if the mode of operation of the system (i.e. semantic relationships) for the surrounding area is known. The task of the system is therefore implemented as a conventional algorithm (instead of as an example-based system). For the areas of the input space for which a statistical system or a neural network is to be used, in step H the statistical system is likewise created or the structure of the neural network is specified and the neural network trained.

FIG. 5 shows by way of example a hierarchical division of an input space 120, by which a hierarchical mapping of the input space is achieved. The collected examples 122 in the set of examples are represented as stars 123 and circles 125 in FIG. 5. The stars 123 and circles 125 are examples of different object classes (i.e. have a different position in the output space).

In the areas in which high complexity is present, a new hierarchy level 126 can additionally be introduced. The new hierarchy level 126 is for example introduced by adding a new subdivision 132 with a higher resolution 134 in the area 130. The procedure can be iterated, by adding a further hierarchy level in the high-resolution area in the event of renewed increased local complexity.

To understand the properties and the behavior of the quality indicators described in WASCHULZIK as examples of a complexity assessment, it is helpful to apply these to synthetic functions (e.g. y=x). From this it is possible to conclude how these quality indicators can be used in example-based systems.

FIGS. 6 to 8 each show for a synthetic function a histogram of the distribution of the complexity assessment over k nearest neighbors of a preselected example. The example is for example a proxy example or a center of a cluster (as described above). The example can moreover be an example selected from the surrounding area of a representative, which was selected for a more thorough examination as regards the complexity of the task.

FIG. 6 shows on the left chart 4.1 and on the right chart 4.4 from WASCHULZIK. As a synthetic function y = x is represented as an axis diagram on the left of FIG. 6 (the entries in the axis diagram are shown as “+”). The axis diagram on the right shows a histogram SHLQ² of QI² of the k nearest neighbors of an example of the function y=x. It can be seen that for any local surrounding areas k of an example the histogram SHLQ² shown has the value zero.

FIG. 7 shows on the left chart 4.17 and on the right chart 4.20 from WASCHULZIK. As a synthetic function y=ru (seed, 300)*300 is represented as an axis diagram in FIG. 7 on the left. This involves an equally distributed chance variable with values between 0 and 300. The axis diagram on the right shows the histogram SHLQ² of QI² of the k nearest neighbors of an example of the function y=ru (seed, 300) *300. The axis diagram in FIG. 7 on the right is scaled such that 40 stands for the value 1.

FIG. 8 shows on the left chart 4.41 and on the right chart 4.44 from WASCHULZIK. As a synthetic function y = sin (8*pi*x/300) + br (seed, 300) is represented as an axis diagram on the left of FIG. 8. This involves a sine function that has stochastic noise in the ranges 0 < x ≤ 50 and 100 < x ≤ 200. The axis diagram on the right shows the histogram SHLQ² of QI² of the k nearest neighbors of an example of the function y = sin(8*pi*x/300) + br (seed, 300) . The axis diagram in FIG. 8 is scaled such that 40 stands for the value 1. The person skilled in the art will recognize in this representation that there are multiple k neighborhoods up to a size of approximately 45 in which the value of QI² is almost 0 (indicated by the dark-gray hatching of the bins with a small number plotted on the V axis), the result being an almost linear chart of the input and output space. If the person skilled in the art now analyzes, by reading out the information in the histogram, in the surrounding area of which examples the low complexity is present, this will result in the example with x=75 in the neighborhood k=45 of which the complexity is very low. The same applies for x=225 or x=275 for k=45. Thus without any prior knowledge of how the examples are distributed in the input space, the person skilled in the art can easily, quickly and reliably identify the areas in which the complexity is particularly low or high. By reading out the bins with the high values even in the case of large surrounding areas it is possible to identify areas with high complexity (e.g. bin number 80 with K=20). This identification of the areas with high or low complexity can take place regardless of the dimension of the input and output space, since the spacing of the k nearest neighbors can be determined in spaces of any dimensionality. The person skilled in the art can use the similar procedure to also identify from the histograms of the size of the relationship areas the representatives in which e.g. very few examples are contained. Using the representative the positions in the input space in which further examples have to be captured can then be determined.

Alternatively to the exemplary embodiment described in respect of FIG. 3, in accordance with which representatives are equally distributed in the input space, FIG. 9 shows an exemplary embodiment of an input space 220 in which the representatives each form a center of a cluster that is determined by means of a cluster method.

The examples 222 in the set of examples are represented in FIG. 9 as cross-hairs 223.

FIG. 9 shows by way of example four clusters 230, 232, 234 and 236, each of which comprises multiple examples. These examples are situated in the representation inside a dashed borderline, which however does not represent an actual boundary of a cluster, but has only been drawn in for the purposes of illustration. The clusters 230, 232, 234 and 236 each have an associated cluster center 240, 242, 244 and 246 (represented in the shape of a plus sign). The cluster centers 240, 242, 244, 246 are each situated centrally inside the cluster and are assigned to a cluster regardless of the borders of the grid of the input space.

The advantage of the clusters in accordance with FIG. 9 is that they represent the topology of the data particularly appropriately. The advantage of the grid in accordance with FIG. 3 is that the areas not covered are more appropriately mapped. For example, the coverage of the input space (in accordance with method step C) can be calculated using the grid, and the complexity assessment (in accordance with method step E) in addition to the grid can also be calculated using the cluster center. Which approach is more appropriate may also depend on the method used by the neural network. If the encoding neurons can move in the input space, the cluster approach is preferably selected or the cluster centers are equated with the positions of the encoding neurons in the input space.

1-20. (canceled)

21. A quality assurance method for an example-based system, the method comprising:
creating and training the example-based system based on collected examples forming a set of examples;
including an input value situated in an input space in a respective example in the set of examples; and
ascertaining a quality assessment representing a coverage of the input space by examples in the set of examples based on a distribution of the input values in the input space.

22. The method according to claim 21, which further comprises ascertaining the quality assessment by:
distributing representatives in the input space;
assigning a number of examples in the set of examples to a respective representative;
placing the examples assigned to the representative in a surrounding area of the input space surrounding the representative; and
ascertaining a local quality assessment for the surrounding area as a quality assessment.

23. The method according to claim 22, which further comprises providing the quality assessment with a statistical average ascertained based on at least one of:
the set of examples or,
the examples assigned to a respective representative.

24. The method according to claim 23, which further comprises creating a histogram of the number of examples assigned to a representative as a statistical average.

25. The method according to claim 22, which further comprises ascertaining a statistical measurement or at least one of an average value, a median, a minimum or quantiles of the number of examples assigned to a representative, as a statistical average.

26. The method according to claim 22, which further comprises ascertaining adjacent surrounding areas in the input space, and assigning a number of examples fulfilling a predefined quality criterion of the quality assessment to a respective representative of the adjacent surrounding areas.

27. The method according to claim 26, which further comprises ascertaining a relationship area inside the input space, forming the relationship area of adjacent surrounding areas, and assigning a number of examples fulfilling a predefined quality criterion of the quality assessment to each of the representatives of the number of examples.

28. The method according to claim 22, which further comprises at least one of:
capturing urther examples in a respective surrounding area when the quality assessment ascertained for the respective surrounding area is less than a predefined quality threshold value, or
removing examples from a respective surrounding area when the quality assessment ascertained for the respective surrounding area is greater than a predefined quality threshold value.

29. The method according to claim 22, which further comprises:
including an output value situated in an output space in the respective example;
ascertaining a local complexity assessment for the respective surrounding area representing a complexity of a task of the example-based system defined by the examples in the surrounding area; and
determining the local complexity assessment by a location of the examples in the surrounding area relative to one another in the input space and the output space.

30. The method according to claim 29, which further comprises ascertaining an aggregated complexity assessment by aggregation of the local complexity assessments.

31. The method according to claim 30, which further comprises:
identifying surrounding areas having a complexity assessment undershooting a predefined complexity threshold value, based on the aggregated complexity assessment; and
implementing the task of the example-based system in the ascertained surrounding areas by an algorithmic solution.

32. The method according to claim 21, which further comprises dividing the input space hierarchically based on the quality assessment.

33. The method according to claim 29, which further comprises ascertaining a complexity distribution by using a histogram representation of the complexity assessment of a plurality of nearest neighbors of an example in the input space.

34. The method according to claim 29, which further comprises:
providing the complexity assessment as an integrated quality indicator QI²,
defining the quality indicator in accordance with:
$$Q {I}^{2} \left(P\right) = \frac{1}{\left|{P}^{2}\right|} {\sum }_{{x}_{i} ∈ {P}^{2}} {\left({d}_{N R E} \left({x}_{i}\right) - {d}_{N R A} \left({x}_{i}\right)\right)}^{2}$$
wherein:
$${d}_{N R E} \left(x\right) = \frac{{d}_{R E} \left(x\right)}{\frac{\sum {}_{y ∈ {P}^{2}} {d}_{R E} \left(y\right)}{\left|{P}^{2}\right|}}$$
is a normalized spacing of the represented inputs, and
$${d}_{N R A} \left(x\right) = \frac{{d}_{R A} \left(x\right)}{\frac{\sum {}_{y ∈ {P}^{2}} {d}_{R A} \left(y\right)}{\left|{P}^{2}\right|}}$$
is a normalized spacing of the represented outputs,
x is a pair (x₁, x₂, ) formed of two examples x₁ and x₂.
x₁ and x₂ are examples from the set of examples P,
P = {p₁, p₁, ..., p_{|P|}} is a set of elements in a multiset BAG P, and

|P| is a number of elements in the multiset BAG P.

35. The method according to claim 21, which further comprises providing the example-based system for use in a safety-oriented function, the safety-oriented function includes object recognition based on image recognition, and the object is recognized by using the example-based system.

36. The method according to claim 35, which further comprises using the object recognition in automated operation of at least one of a vehicle, a track-bound vehicle, a motor vehicle, an aircraft, a water vehicle or a space vehicle.

37. The method according to claim 21, which further comprises providing the example-based system for use in a safety-oriented function, and using the safety-oriented function to represent a classification based on at least one of sensor data of organisms, safe control of industrial plants, classification of chemical substances, signatures of vehicles or control in an area of industrial automation.

38. The method according to claim 21, which further comprises providing the example-based system with:
a system with supervised learning,
an artificial neural network with one or more layers of neurons not being input neurons or output neurons and being trained with backpropagation,
a convolutional neural network, or
a single-shot multibox detector network.

39. A computer program stored on a non-transitory computer-readable medium, comprising instructions stored thereon that when executed by a computer cause the computer to carry out the method according to claim 21.

40. A non-transitory computer-readable medium, comprising instructions stored thereon that when executed by a computer cause the computer to carry out the method according to claim 21.
